(19) United States
(12) Patent Application Publication
(10) Pub. No.: US 2022/0282099 A1
(43) Pub. Date: Sep. 8, 2022

(54) ADHERENT AMORPHOUS PERFLUOROPOLMER COMPOSITION

(71) Applicant: THE CHEMOURS COMPANY FC, LLC, Wilmington, DE (US)

(72) Inventor: XUDONG CHEN, Hockessin, DE (US)

(21) Appl. No.: 17/634,760

(22) PCT Filed: Aug. 11, 2020
(86) PCT No.: PCT/US2020/045736

§ 371 Date: Feb. 11, 2022

Related U.S. Application Data
(60) Provisional application No. 62/885,388, filed on Aug. 12, 2019.

(51) Int. Cl. C09D 7/20; C09D 7/65; C03C 17/32

(52) U.S. Cl. CPC C09D 7/20; C09D 7/65; C03C 17/32

(57) ABSTRACT

Provided is a fluoropolymer composition containing amorphous perfluoropolymer as a major component and functional fluoropolymer as a minor component, the functional fluoropolymer containing copolymerized units of fluoroolefin, alkyl or aryl vinyl ether and alkenyl silane. The minor amount of the functional fluoropolymer results in the fluoropolymer composition strongly adhering to a variety of substrates, but not suffering significant degradation of the desirable properties of the amorphous perfluoropolymer.

### CROSS-REFERENCE TO RELATED APPLICATIONS

This application claims the benefit of U.S. Provisional Patent Application 62/885,388, filed Aug. 12, 2019, which is incorporated by reference herein in its entirety.

### FIELD OF THE DISCLOSURE

This application relates to fluoropolymer compositions containing amorphous perfluoropolymer and functional fluoropolymer, the compositions having utility as adherent protective coatings.

### BACKGROUND OF THE DISCLOSURE

Perfluoropolymers such as polytetrafluoroethylene (PTFE) and perfluoroalkoxy polymer (PFA) are known to have very desirable physical properties and appreciate wide commercial utility. Amorphous perfluoropolymers are a species of perfluoropolymer that have special properties making them commercially desirable in a variety of special utilities in the electronics industry. Amorphous perfluoropolymers, especially the copolymers of tetrafluoroethylene (TFE) and perfluoro(2,2-dimethyl-1,3-dioxole) (PDD), for example manufactured by The Chemours Company under the product name Teflon™ AF, have similar optical and mechanical properties to the perfluoropolymers PTFE and PFA, but are unique in many commercially desirable ways. For example Teflon™ AF has somewhat higher coefficient of friction than PTFE and PFA, excellent mechanical and physical properties at end-use temperatures up to 300° C., and excellent light transmission from ultra-violet through a good portion of the infrared. Additionally, the Teflon™ AF polymers are distinct from other perfluoropolymers in that they are soluble in select fluorinated solvents, have high gas permeability, high compressibility, high creep resistance, low thermal conductivity, and have the lowest dielectric constant of any known solid polymer even at gigahertz frequencies and have the lowest index of refraction of any known polymer.

However, despite such an impressive array of commercially desirable properties, amorphous perfluoropolymers suffer from poor adhesion to common substrates like plastics and glass. Such poor adhesion can undesirably result in delamination or separation of an amorphous perfluoropolymer coating from a substrate upon use, for example in an electronic device, and result in poor performance or even failure of the device.

Various modifications have been disclosed in the art for the purpose of improving the adhesion of amorphous perfluoropolymer to substrates. For example, JPH08100146 discloses blending Teflon™ AF with an ink for screen printing. U.S. Pat. No. 5,118,579, discloses blends of amorphous fluoropolymer with 5-99 wt % of a fluorinated copolymer derived from (a) perfluoroalkyl acrylate or methacrylate, (b) acrylic, methacrylic or itaconic acid, and (c) a hydroxyl-containing acrylate or methacrylate.

As disclosed in the art, when the amount of the adhesive component added to the amorphous fluoropolymer is too small, the adhesivity of the amorphous fluoropolymer to substrates is not satisfactorily improved. On the other hand, when the amount of the adhesive component added to the amorphous fluoropolymer is too large, adhesivity to substrates may be acceptable, but the fundamental desirable properties of the amorphous fluoropolymer are significantly degraded, and further the stability of coating solutions of the amorphous perfluoropolymer becomes poor, possibly undesirable resulting in gelation.

Thus, there continues to be a commercially unmet need for amorphous perfluoropolymer with improved adhesion to substrates wherein the improved adhesion does not come at the expense of significant degradation of the fundamental desirable properties of the amorphous perfluoropolymer.

### SUMMARY OF THE DISCLOSURE

The present inventive fluoropolymer composition overcomes the problems associated with the prior art by providing an amorphous perfluoropolymer composition containing a minor but effective amount of a functional fluoropolymer. The present fluoropolymer composition has good adhesion to substrates but does not suffer significant degradation of the desirable fundamental properties of the amorphous perfluoropolymer.

Therefore, in accordance with the present invention, there is provided a fluoropolymer composition comprising: i) amorphous perfluoropolymer comprising copolymerized units of at least one perfluorinated monomer, and ii) functional fluoropolymer comprising copolymerized units of (a) fluoroolefin, (b) alkyl vinyl ether or aryl vinyl ether and (c) alkenyl silane, i) and ii) being defined in detail subsequently herein.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

### DETAILED DESCRIPTION OF THE INVENTION

The foregoing general description and the following detailed description are exemplary and explanatory only and are not restrictive of the invention, as defined in the appended claims. Other features and benefits of any one or more of the embodiments will be apparent from the following detailed description, and from the claims.

### Definitions and Abbreviations

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

When an amount, concentration, or other value or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

As used herein, the term “consisting essentially of” is used to define a composition, method that includes materials, steps, features, components, or elements, in addition to those literally disclosed provided that these additional included materials, steps, features, components, or elements do not materially affect the basic and novel characteristic(s) of the claimed invention, especially the mode of action to achieve the desired result of any of the processes of the present invention. The term “consists essentially of” or “consisting essentially of” occupies a middle ground between “comprising” and “consisting of”.

### Fluoropolymer Composition

The present fluoropolymer composition comprises amorphous perfluoropolymer and functional fluoropolymer. In other embodiments, the present fluoropolymer composition consists essentially of, or alternately, consists of, amorphous perfluoropolymer and functional fluoropolymer.

The fluoropolymer composition contains an amount of functional fluoropolymer effective to improve the adhesion of amorphous perfluoropolymer to a substrate without significantly degrading desirable properties of the amorphous perfluoropolymer. The present inventor has discovered that an amount of from as little as about 0.5 wt % of functional fluoropolymer mixed together with the amorphous perfluoropolymer is effective to substantially improve adhesion of the amorphous perfluoropolymer to substrates as required for many applications, however without significantly degrading the desirable fundamental properties of the amorphous perfluoropolymer in such applications. The present inventor has discovered that an amount of about 5 wt % is the upper desirable limit of the amount of functional fluoropolymer contained in the amorphous perfluoropolymer for this purpose. Although adhesion of the amorphous perfluoropolymer to a substrate may be further improved using greater amounts of functional fluoropolymer, the desirable fundamental properties of the amorphous perfluoropolymer begin to significantly degrade, possibly resulting in the amorphous perfluoropolymer being unacceptable for the given application.

In one embodiment, the amount of functional fluoropolymer contained in the amorphous perfluoropolymer is from about 0.5 wt % to about 5 wt %, based on the combined weights of functional fluoropolymer and amorphous perfluoropolymer. In another embodiment, this amount is from about 0.5 to about 4 wt %. In another embodiment, this amount is from about 0.5 to about 3 wt %. In another embodiment, this amount is from about 0.5 to about 2 wt %. In another embodiment, this amount is from about 1 to about 2 wt %. In another embodiment, this amount is from about 0.5 to about 1 wt %.

### Liquid Composition

The present invention includes in one embodiment a liquid composition of fluoropolymer comprising a fluorinated solvent having dissolved therein the present fluoropolymer composition comprising amorphous perfluoropolymer and functional fluoropolymer.

These liquid compositions can be prepared by known methods, for example, by powder blending of the polymer components followed by dissolution in a suitable fluorinated solvent, or by separately dissolving the amorphous perfluoropolymer and functional fluoropolymer in a fluorinated solvent suitable for both of these polymers, followed by mixing together of these individual solutions.

Suitable fluorinated solvents are those in which each of the amorphous perfluoropolymer and the functional fluoropolymer have appreciable solubility so as to be able to form useful liquid coating compositions, e.g., solutions containing up to about 15 wt % of dissolved solids. The maximum weight percent solution of amorphous perfluoropolymer and functional fluoropolymer that can be formed will essentially depend on the molecular weight of the relatively higher molecular weight and less soluble amorphous perfluoropolymer, with the relatively higher molecular weight amorphous perfluoropolymers (e.g., such as Teflon™ AF1600 and AF2400 from The Chemours Co.) having maximum useful solubility at room temperature, without resulting in a solution that is too viscous for forming coatings, of about 4 wt % in suitable fluorinated solvents. The desired amount of dissolved solids will control the desired thickness of a resultant coating depending on the coating method, which can be routinely determined and optimized by the skilled practitioner. Example fluorinated solvents include Fluorinert™ fluorinated solvents manufactured by 3M™, such as the fluorinated amine FC-40 (1,1,2,2,3,3,4,4,4-nonafluoro-N-(1,1,2,2,3,3,4,4,4-nonafluorobutyl)-N-(1,1,2,2-tetrafluoroethyl)butan-1-amine). Further examples include the Novec™ Engineered Fluids manufactured by 3M™, for example 7100 and 7100DL (C₄F₉OCH₃), and 7200 and 7200DL (C₄F₉OCH₂CH₃). These fluorinated solvents can be used alone or in combination with a cosolvent. The resultant liquid compositions can be mixed, in the desired proportions to obtain blends within the above-stated limits. The resultant mixture can be applied in a conventional manner to the desired substrate, the solvent evaporated, and the residue blended fluoropolymer coating can be cured (dried) by application of heat to form a robust, strongly adherent fluoropolymer coating.

In one embodiment the present liquid composition contains about 4 weight percent or less of the present fluoropolymer composition dissolved in a fluorinated solvent.

In one embodiment, the present liquid composition comprises fluorinated solvent and fluoropolymer composition dissolved in the fluorinated solvent, wherein the fluoropolymer composition comprises amorphous perfluoropolymer comprising copolymerized units of tetrafluoroethylene and perfluoro(2,2-dimethyl-1,3-dioxole), and functional fluoropolymer comprising copolymerized units arising from tetrafluoroethylene, ethyl vinyl ether, and vinyltriisopropoxysilane, the functional fluoropolymer having a weight average molecular weight of from 50,000 to 330,000 daltons, the fluorinated solvent being C₄F₉OCH₃ or C₄F₉OC₂H₅, and the liquid composition containing about 4 wt % weight percent or less of dissolved fluoropolymer composition.

In another embodiment, the present liquid composition comprises fluorinated solvent and fluoropolymer composition dissolved in the fluorinated solvent, wherein the fluoropolymer composition comprises amorphous perfluoropolymer comprising copolymerized units of tetrafluoroethylene and perfluoro(2,2-dimethyl-1,3-dioxole), and functional fluoropolymer comprising from about 40 to about 60 mole percent repeat units arising from tetrafluoroethylene, from about 40 to about 60 mole percent repeat units arising from ethyl vinyl ether, and from about 0.2 to about 10 mole percent of repeat units arising from vinyltriisopropoxysilane, the functional fluoropolymer having a weight average molecular weight of from about 50,000 to about 330,000 daltons, the fluorinated solvent being C₄F₉OCH₃ or C₄F₉OC₂H₅, and the liquid composition containing about 4 wt % weight percent or less of the fluoropolymer composition.

### Coated Article and Coating Process

The present coated article comprises a substrate having a coating of the present fluoropolymer composition comprising amorphous perfluoropolymer and functional fluoropolymer.

The coating of the present fluoropolymer composition can be formed on a variety of substrates, including electrically conductive materials, semiconductive materials and/or nonconductive materials. For example, the substrate can be glass, polymeric, inorganic semiconductor, organic semiconductor, tin oxide, zinc oxide, titanium dioxide, silicon dioxide, indium oxide, indium zinc oxide, zinc tin oxide, indium gallium oxide, indium gallium zinc oxide, indium tin zinc oxide, cadmium sulfide, cadmium selenide, silicon, silicon nitride, germanium, gallium arsenide, copper, aluminum or a combination thereof. In a preferred embodiment the substrate comprises silicon dioxide.

The fluoropolymer coating of the present fluoropolymer composition can be formed on a substrate by a process involving the step of (I) applying a liquid composition onto at least a portion of a substrate, wherein the liquid composition comprises a fluorinated solvent having dissolved therein the present fluoropolymer composition comprising amorphous perfluoropolymer and functional fluoropolymer. The application of the coating of the liquid composition onto at least a portion of the substrate can be carried out by conventional coating processes, such as by spin coating, spray coating, flow coating, curtain coating, roller coating, brushing, inkjet printing, screen printing, offset printing, gravure printing, flexographic printing, lithographic printing, dip coating, blade coating or drop coating methods. In a preferred embodiment, spin coating is used, which involves applying an excess amount of the liquid composition to the substrate, then rotating the substrate at high speeds to evenly spread and distribute the composition across the surface of the substrate by centrifugal force. The thickness of the resultant fluoropolymer coating can be dependent on the spin coating rate, the concentration of the solution, as well as the solvent used, which can be easily established by one skilled in this field.

The present process for forming a fluoropolymer coating on a substrate further involves the step of (II) removing at least a portion of the solvent from the coated solution. After application of the liquid composition to the substrate, at least a portion of, or alternately substantially all of, the solvent can be removed from the coated solution by exposing the coating to elevated temperatures, exposure to less than atmospheric pressure, by directly or indirectly blowing gas onto the applied layer or by using a combination of these methods. For example, the applied fluoropolymer coating may be heated in air or in a vacuum oven optionally with a purge of nitrogen gas. In other embodiments, the coating can be heated to a temperature in the range of from about 60 to about 110° C. in order to remove the solvent.

In one embodiment, the present fluoropolymer coating on a substrate has a thickness of from about 0.025 to about 100 micrometers. In another embodiment, the present fluoropolymer coating has a thickness of from about 0.1 to about 50 micrometers. In another embodiment, the present fluoropolymer coating has a thickness of from about 4 micrometers to about 10 micrometers. In another embodiment, the present fluoropolymer coating has a thickness of from about 0.2 to about 2 micrometers. In another embodiment, the present fluoropolymer coating has a thickness of about 1 micrometers. In another embodiment, the present fluoropolymer coating has a thickness of from about 0.070 to about 0.2 micrometers. In another embodiment, the present fluoropolymer coating has a thickness of from about 0.025 to about 0.1 micrometers.

In one embodiment the present invention is a process for forming a fluoropolymer coating on a substrate, comprising: (1) applying a coating of liquid composition onto at least a portion of a substrate, wherein the liquid composition comprises a fluorinated solvent having dissolved therein a fluoropolymer composition comprising present amorphous perfluoropolymer and present functional fluoropolymer, and (II) removing at least a portion of the solvent from the coated solution, and optionally (Ill) heat curing to form the fluoropolymer coating.

### Properties of the Fluoropolymer Coating

Sliding angle is a measurable property of coatings, and is a measure of adhesion force for liquid-water droplets to a surface by observation of droplet mobility and detachment from the surface. In other words, sliding angle relates to how “sticky” a coating is toward removal of liquids from the coating surface. To measure sliding angle, and as was used to measure sliding angle of coatings of the present application, an instrument known as a Goniometer is used at room temperature to record the angle between the sample/coating surface and the horizontal plane at which a drop of deionized water begins to slide off of the sample surface under gravity influence. Liquid contaminants remaining on the surface of an article, for example electronic and optical device surfaces, are generally undesirable. Depending on the article and its utility, such contaminants can deteriorate desirable functionality of the article, such as important heat, electrical signal and light transfer, or blocking, capabilities. Such contaminants remaining on the surface of an article can penetrate pores in the surface, carrying contaminants into the interior of the article, and lead to undesirable destructive processes such a corrosion and etching. A coating having a relatively low sliding angle is typically more desirable for utility as a surface-protective coating. Such a coating will more frequently shed liquid contaminants from the article surface, rather than the liquid contaminant remaining on the surface and possibly infiltrating the surface or evaporating from the surface and thereby undesirably depositing other dissolved or dispersed contaminants or carrying out the aforementioned destructive processes.

The present inventor has discovered that the presence of the small amount of the present functional fluoropolymer mixed with the present amorphous perfluoropolymer results in a fluoropolymer coating having surprisingly improved adhesion to substrates over the adhesion of a like coating containing only the amorphous perfluoropolymer component (i.e., amorphous perfluoropolymer free from functional fluoropolymer). Further, the desirably low sliding angle of the amorphous perfluoropolymer, which comprises the majority of the present fluoropolymer coating, is not significantly degraded by the presence of the functional fluoropolymer, which is surprising considering the poor (relatively large) sliding angle of the present functional fluoropolymers.

Thus, one embodiment of the present invention includes a coated article comprising a substrate having a fluoropolymer coating, the fluoropolymer coating comprising the present amorphous perfluoropolymer and the present functional fluoropolymer, wherein the fluoropolymer coating contains a relatively small amount of the functional fluoropolymer based on the combined weights of the amorphous perfluoropolymer and the functional fluoropolymer, and the fluoropolymer coating has greater adhesion to the substrate than the adhesion of an equivalent coating containing only the amorphous perfluoropolymer, and the fluoropolymer coating has properties substantially equivalent to those of the amorphous perfluoropolymer, properties that are not significantly degraded by the presence of the functional fluoropolymer.

In another embodiment, the present invention includes a coated article comprising a substrate having a fluoropolymer coating comprising a fluoropolymer composition, wherein the fluoropolymer composition comprises
i) amorphous perfluoropolymer comprising copolymerized units of tetrafluoroethylene and perfluoro(2,2-dimethyl-1,3-dioxole), and
ii) functional fluoropolymer comprising copolymerized units of
   (a) tetrafluoroethylene;
   (b) alkyl vinyl ether wherein the alkyl group is a C1 to C6 straight chain alkyl radical or a C3 to C6 branched chain or cyclic alkyl radical, or aryl vinyl ether wherein the aryl group is unsubstituted or substituted; and
   (c) alkenyl silane of the formula SiR1R2R3R4, wherein R1 is an alkenyl radical, R2 and R3 are independently selected from substituted or unsubstituted aryl, substituted or unsubstituted aryl substituted alkyl radical, substituted or unsubstituted linear or branched alkoxy radical, substituted or unsubstituted cyclic alkoxy radical, substituted or unsubstituted linear or branched alkyl radical, or substituted or unsubstituted cyclic alkyl radical, and R4 is substituted or unsubstituted linear or branched alkoxy radical, or substituted or unsubstituted cyclic alkoxy radical, and
the fluoropolymer composition containing from about 1 to about 5 weight percent of the functional fluoropolymer based on the combined weight of the amorphous perfluoropolymer and the functional fluoropolymer, and
the adhesion of the coating to the substrate as determined by the ASTM D3359 method results in at least about 75% of the coating squares remaining in the 5×5 test matrix, and
the sliding angle as measured by Goniometer is about 27 degrees or less.

In another embodiment, the present invention includes a coated article comprising a substrate having a fluoropolymer coating comprising a fluoropolymer composition, wherein the fluoropolymer composition comprises
i) amorphous perfluoropolymer comprising copolymerized units of tetrafluoroethylene and perfluoro(2,2-dimethyl-1,3-dioxole), and
ii) functional fluoropolymer comprising copolymerized units of
   (a) tetrafluoroethylene;
   (b) alkyl vinyl ether wherein the alkyl group is a C1 to C6 straight chain alkyl radical or a C3 to C6 branched chain or cyclic alkyl radical, or aryl vinyl ether wherein the aryl group is unsubstituted or substituted; and
   (c) alkenyl silane of the formula SiR1R2R3R4, wherein R1 is an alkenyl radical, R2 and R3 are independently selected from substituted or unsubstituted aryl, substituted or unsubstituted aryl substituted alkyl radical, substituted or unsubstituted linear or branched alkoxy radical, substituted or unsubstituted cyclic alkoxy radical, substituted or unsubstituted linear or branched alkyl radical, or substituted or unsubstituted cyclic alkyl radical, and R4 is substituted or unsubstituted linear or branched alkoxy radical, or substituted or unsubstituted cyclic alkoxy radical, and
the fluoropolymer composition containing from about 2 to about 3 weight percent of the functional fluoropolymer based on the combined weight of the amorphous perfluoropolymer and the functional fluoropolymer, and
the adhesion of the coating to the substrate as determined by the ASTM D3359 method results in about 100% of the coating squares remaining in the 5×5 test matrix, and
the sliding angle as measured by Goniometer is about 26 degrees or less.

### Process

The present disclosure includes an inventive process for improving the adhesion of amorphous perfluoropolymer to a substrate, in one embodiment silicon dioxide, comprising
combining said amorphous perfluoropolymer with a functional fluoropolymer to form a fluoropolymer composition, and
forming a coating of said fluoropolymer composition on at least a portion of the surface of said substrate,
whereby said coating has greater adhesion to said substrate than the adhesion of an identical coating substantially free from functional fluoropolymer, and
wherein said functional fluoropolymer comprises copolymerized units of: (a) fluoroolefin selected from the group consisting of tetrafluoroethylene, chlorotrifluoroethylene, hexafluoropropylene, perfluoro(methyl vinyl ether), perfluoro(ethyl vinyl ether), and perfluoro(propyl vinyl ether); (b) alkyl vinyl ether wherein the alkyl group is a C1 to C6 straight chain alkyl radical or a C3 to C6 branched chain or cyclic alkyl radical, or aryl vinyl ether wherein the aryl group is unsubstituted or substituted; and (c) alkenyl silane of the formula SiR1R2R3R4, wherein R1 is an alkenyl radical, R2 and R3 are independently selected from substituted or unsubstituted aryl, substituted or unsubstituted aryl substituted alkyl radical, substituted or unsubstituted linear or branched alkoxy radical, substituted or unsubstituted cyclic alkoxy radical, substituted or unsubstituted linear or branched alkyl radical, or substituted or unsubstituted cyclic alkyl radical, and R4 is substituted or unsubstituted linear or branched alkoxy radical, or substituted or unsubstituted cyclic alkoxy radical.

### Amorphous Perfluoropolymer

One component of the present fluoropolymer composition is amorphous perfluoropolymer. By amorphous is meant that the heat of fusion calculated from any endotherm detected in a differential scanning calorimetry (DSC) scan for as-polymerized resin is no more than about 3 J/g, preferably no more than about 1 J/g. Generally, no endotherm is seen in a second DSC heating even if a weak endotherm is detected for first heating.

The amorphous perfluoropolymer comprises copolymerized units of at least one perfluorinated monomer. In a preferred embodiment, the amorphous perfluoropolymer comprises copolymerized units of tetrafluoroethylene (TFE) and at least one additional perfluorinated monomer. The perfluorinated monomer can be any perfluorinated monomer known to productively polymerize with TFE to form amorphous perfluoropolymer. Examples of such perfluorinated monomers include: hexafluoropropylene (HFP); perfluoro(alkyl vinyl ethers), such as perfluoro(methyl vinyl ether) (PMVE), perfluoro(ethyl vinyl ether) (PEVE), and perfluoro(propyl vinyl ether) (PPVE); perfluoro(1,3-dioxole); perfluoro(2,2-dimethyl-1,3-dioxole) (PDD); perfluoro(2-methylene-4-methyl-1,3-dioxolane) (PMD); CF₂═CFOCF₂CF═CF₂, CF₂═CFOCF₂CF₂CF═CF₂; and CF₂═CFOCF₂CF₂OCF═CF₂. The previous three listed dienes are known to form cyclic repeat structures, as described in U.S. Pat. No. 5,296,283.

In a preferred embodiment, the amorphous perfluoropolymers are those derived from TFE and perfluoro(2,2-dimethyl-1,3-dioxole) (PDD). Amorphous dipolymers with TFE contain at least about 11 mole % PDD, and as the amount of PDD in the dipolymer increases, so does the glass transition temperature (Tg) of the dipolymer, although not necessarily in linear fashion. Dipolymers containing about 65-99 mole % of PDD have Tgs of 140° C. or higher.

In one embodiment the amorphous perfluoropolymer is PDD homopolymer, which is an excellent coating material, which has many useful properties, including a very high Tg, in excess of 300° C., except that it is at present very expensive.

Both the PDD homopolymer and the TFE/PDD dipolymer are extremely resistant to corrosive environment, including hydrofluoric acid and hydrogen fluoride, are perfectly clear and transparent to a broad range of light frequencies, including the visible and the ultraviolet light. Furthermore, these polymers are soluble in a commercially available fluorinated solvents. Because of that, they can be applied from solution, for example, by spray-coating, dip-coating, brushing, or rolling onto the surface to be protected. After air-drying, the coated article can be heat-treated, for instance, at 160° C. for approximately 15 minutes. A good concentration of polymer to use for such applications is about 3% by weight.

The amorphous perfluoropolymers that are useful in the practice of the present invention are well known, and some of them are commercially available. For example, many amorphous copolymers of PDD as well as various processes for making them are described in U.S. Pat. Nos. 4,530,569 and 4,754,009. The homopolymer of PDD is disclosed in U.S. Pat. No. 3,978,630. A homopolymer of perfluoro(1,3-dioxole) and copolymers with tetrafluoroethylene are described in U.S. Pat. No. 4,485,250.

### Functional Fluoropolymer

Another component of the present fluoropolymer composition is functional fluoropolymer. As used herein functional fluoropolymer refers to fluoropolymer comprising copolymerized units of: (a) fluoroolefin selected from the group consisting of tetrafluoroethylene, chlorotrifluoroethylene, hexafluoropropylene, perfluoro(methyl vinyl ether), perfluoro(ethyl vinyl ether), and perfluoro(propyl vinyl ether); (b) alkyl vinyl ether wherein the alkyl group is a C1 to C6 straight chain alkyl radical or a C3 to C6 branched chain or cyclic alkyl radical, or aryl vinyl ether wherein the aryl group is unsubstituted or substituted; and (c) alkenyl silane of the formula SiR1R2R3R4, wherein R1 is an ethylenically unsaturated hydrocarbon radical, R2 and R3 are independently selected from substituted or unsubstituted aryl, substituted or unsubstituted aryl substituted hydrocarbon radical, substituted or unsubstituted linear or branched alkoxy radical, substituted or unsubstituted cyclic alkoxy radical, substituted or unsubstituted linear or branched alkyl radical, or substituted or unsubstituted cyclic alkyl radical, and R4 is substituted or unsubstituted linear or branched alkoxy radical, or substituted or unsubstituted cyclic alkoxy radical.

The present functional fluoropolymer includes copolymerized units arising from fluoroolefin monomer. Fluoroolefin is at least one monomer selected from the group consisting of tetrafluoroethylene, chlorotrifluoroethylene, hexafluoropropylene, perfluoro(methyl vinyl ether), perfluoro(ethyl vinyl ether), and perfluoro(propyl vinyl ether). In some embodiments, in addition to these fluoroolefins, the functional fluoropolymer can contain repeat units arising from other fluorinated monomers capable of copolymerizing into the present functional fluoropolymer, including: trifluoroethylene, vinyl fluoride, vinylidene fluoride, perfluorodimethyldioxole, trifluoropropylene, perfluoro(2-methylene-4-methyl-1,3-dioxolane, hexafluoroisobutylene, methyl 3-[1-[difluoro[(trifluorovinyl)oxy]methyl]-1,2,2,2-tetrafluoroethoxy]-2,2,3,3-tetrafluoropropionate, 2-[1-[difluoro[(1,2,2-trifluoroethenyl)oxy]methyl]-1,2,2,2-tetrafluoroethoxy]-1,1,2,2-tetrafluoro-ethanesulfonyl fluoride, or a combination thereof. In some embodiments, the fluoroolefin monomers forming the functional fluoropolymer can consist of, or consist essentially of, the aforementioned fluoroolefins.

Fluoroolefin is incorporated into the functional fluoropolymer in an amount of from about 40 to about 60 mole percent, based on the total amount of copolymerized units in the functional fluoropolymer. In some embodiments, fluoroolefin is incorporated into the functional fluoropolymer in an amount of from about 42 to about 58 mole percent. In other embodiments, fluoroolefin is incorporated into the functional fluoropolymer in an amount of from about 45 to about 55 mole percent.

The present functional fluoropolymer includes copolymerized units arising from at least one alkyl vinyl ether monomer and/or aryl vinyl ether monomer. Alkyl vinyl ethers as used herein are those wherein the alkyl group is a C1 to C6 straight chain alkyl radical or a C3 to C6 branched chain or cyclic alkyl radical. Example alkyl vinyl ethers include methyl vinyl ether, ethyl vinyl ether, n-propyl vinyl ether, isopropyl vinyl ether, n-butyl vinyl ether, sec-butyl vinyl ether, t-butyl vinyl ether, n-pentyl vinyl ether, isoamyl vinyl ether, hexyl vinyl ether, and cyclohexyl vinyl ether. In some embodiments, the alkyl vinyl ether consists of or consists essentially of methyl vinyl ether, ethyl vinyl ether, n-propyl vinyl ether, isopropyl vinyl ether or a combination thereof. Aryl vinyl ether as used herein are those wherein the aryl group is unsubstituted (phenyl) or substituted (e.g., alkylphenyl (e.g., tolyl, xylyl, —C₆H₄(CH₂CH₃)), halophenyl, aminophenyl). Example aryl vinyl ethers include phenyl vinyl ether.

Alkyl and/or aryl vinyl ethers are incorporated into the functional fluoropolymer in an amount of from about 40 to about 60 mole percent, based on the total amount of copolymerized units in the functional fluoropolymer. In some embodiments, alkyl and/or aryl vinyl ether is incorporated into the functional fluoropolymer in an amount of from about 42 to about 58 mole percent. In other embodiments alkyl and/or aryl vinyl ether is incorporated into the functional fluoropolymer in an amount of from about 45 to about 55 mole percent.

The present functional fluoropolymer includes copolymerized units arising from at least one alkenyl silane monomer. In one embodiment, alkenyl silane as used herein correspond to the general formula SiR1R2R3R4, wherein R1 is an alkenyl radical, R2 and R3 are independently selected from substituted or unsubstituted aryl, substituted or unsubstituted aryl substituted alkyl radical, substituted or unsubstituted linear or branched alkoxy radical, substituted or unsubstituted cyclic alkoxy radical, substituted or unsubstituted linear or branched alkyl radical, or substituted or unsubstituted cyclic alkyl radical, and R4 is substituted or unsubstituted linear or branched alkoxy radical, or substituted or unsubstituted cyclic alkoxy radical. In a preferred embodiment, alkenyl silane as used herein correspond to the general formula SiR1R2R3R4, wherein R1 is an alkenyl radical, R2 is aryl, aryl substituted hydrocarbon radical, branched C3-C6 alkoxy radical, or substituted or unsubstituted cyclic C5-C6 alkoxy radical, and R3 and R4 are independently selected from linear or branched C1-C6 alkoxy radical, or substituted or unsubstituted cyclic C5-C6 alkoxy radical.

In one embodiment the alkenyl silane R1 alkenyl radical is an ethylenically unsaturated hydrocarbon radical capable of productively copolymerizing into the functional fluoropolymer backbone together with fluoroolefin and alkyl or aryl vinyl ether. In some embodiments the alkenyl radicals are those having from 2 to 5 carbon atoms. In some embodiments the alkenyl radical is ethenyl (vinyl), 2-propenyl (allyl), 1-propenyl, 2-butenyl, 1,3-butadienyl, 2-pentenyl, and the like. In a preferred embodiment the alkenyl radical is ethenyl.

In one embodiment the alkenyl silane R2 radical is aryl, aryl substituted alkyl radical, branched C3-C6 alkoxy radical or substituted or unsubstituted cyclic C5-C6 alkoxy radical. The R2 radical is a relatively sterically bulky substituent bonded to the silicon atom of the silane. This allows for productive copolymerization and incorporation of the alkenyl silane through the alkenyl radical into the functional fluoropolymer backbone chain, and also results in the functional fluoropolymer having phase stable shelf-life, for example, such that it remains a dissolved in organic solvent and does not undesirably form gel at ambient temperatures and without special precautions for at least 3 months (e.g, does not form gel through hydrolysis of the silane alkoxy radicals, followed by silicon-oxygen crosslinking (e.g., —Si—O—Si—)). In one embodiment R2 is aryl, for example phenyl, naphthyl or the like. In another embodiment R2 is an aryl substituted alkyl radical, for example benzyl, —CH₂CH₂CsH₅, or the like. In another embodiment R2 is a branched C3-C6 alkoxy radical. In another embodiment R2 is a substituted or unsubstituted cyclic C5-C6 alkoxy radicals. Example R2 radicals include isopropoxy (—OCH(CH₃)CH₃, 2-propoxy), isobutoxy (1-methylpropoxy, —OCH(CH₃)CH₂CH₃), secbutoxy (2-methylpropoxy, —OCH₂CH(CH₃)CH₃)), tertbutoxy (2-methyl-2-propoxy, —OC(CH₃)₃)), and the like. In a preferred embodiment R2 is isopropoxy.

In one embodiment the alkenyl silane R3 and R4 radicals are independently selected from linear or branched C1-C6 alkoxy radicals, or substituted or unsubstituted cyclic C5-C6 alkoxy radicals. In one embodiment, R3 and R4 are identical.

In one embodiment the alkenyl silane is a trialkoxy silane in which the R2, R3, and R4 radicals are identical.

Example alkenyl silanes include: vinyltriisopropoxysilane, allyltriisopropoxysilane, butenyltriisopropoxysilane, and vinylphenyldimethoxysilane. In a preferred embodiment, the alkenyl silane monomer is vinyltriisopropoxysilane. In some embodiments, the alkenyl silane consists of, or consists essentially of vinyltriisopropoxysilane. Such alkenyl silanes are commercially available, for example from Gelest Inc., Morrisville, Pa., USA.

In one embodiment, the functional fluoropolymer consists essentially of, or alternately, consists of, copolymerized units arising from the monomers tetrafluoroethylene, methyl vinyl ether and vinyltriisopropoxysilane. In one embodiment, the functional fluoropolymer consists essentially of, or alternately, consists of, copolymerized units arising from the monomers tetrafluoroethylene, ethyl vinyl ether and vinyltriisopropoxysilane.

In accordance with some embodiments, alkenyl silane is incorporated into the functional fluoropolymer in an amount of from about 0.2 to about 10 mole percent, based on the total amount of monomers used to form the functional fluoropolymer. In other embodiments, alkenyl silane is incorporated into the fluoropolymer in an amount of from about 1.2 to about 8 mole percent, and, in still other embodiments, in an amount of from about 1.4 to about 7 mole percent.

In one embodiment, the functional fluoropolymer comprises from about 40 to about 60 mole percent repeat units arising from fluoroolefin, from about 40 to about 60 mole percent repeat units arising from alkyl vinyl ether or aryl vinyl ether, and from about 0.2 to about 10 mole percent of repeat units arising from alkenyl silane. In one embodiment, the functional fluoropolymer consists essentially of from about 40 to about 60 mole percent repeat units arising from fluoroolefin, from about 40 to about 60 mole percent repeat units arising from alkyl vinyl ether or aryl vinyl ether, and from about 0.2 to about 10 mole percent of repeat units arising from alkenyl silane. In one embodiment, the functional fluoropolymer consists of from about 40 to about 60 mole percent repeat units arising from fluoroolefin, from about 40 to about 60 mole percent repeat units arising from alkyl vinyl ether or aryl vinyl ether, and from about 0.2 to about 10 mole percent of repeat units arising from alkenyl silane.

In accordance with some embodiments, the functional fluoropolymer has a weight average molecular weight of from about 10,000 to about 350,000 daltons. In accordance with other embodiments, the functional fluoropolymer has a weight average molecular weight of from about 100,000 to about 350,000 daltons. In other embodiments, functional fluoropolymer weight average molecular weight can be in a range comprising a minimum weight average molecular weight to a maximum weight average molecular weight wherein the minimum is about 10,000, or about 20,000, or about 30,000, or about 40,000, or about 50,000, or about 60,000, or about 70,000, or about 80,000, or about 90,000, or about 100,000, or about 110,000, or about 120,000, or about 125,000, or about 130,000, or about 140,000, or about 150,000, or about 160,000 or about 170,000 and the maximum is about 350,000, or about 340,000, or about 330,000, or about 320,000, or about 310,000 or about 300,000 daltons. In one embodiment the functional fluoropolymer has a weight average molecular weight of about 200,000 daltons.

Methods of manufacture of such functional fluoropolymers comprising copolymerized units of fluoroolefin, alkyl vinyl ether and alkenyl silane are known in the art, for example, such as the methods disclosed in WO 2017/136266 A1, the disclosure of which is herein incorporated by reference.

### EXAMPLES

### Materials

Teflon™ AF1600 (amorphous perfluoropolymer (AF))—amorphous copolymer of tetrafluoroethylene and perfluoro(2,2-dimethyl-1,3-dioxole) having a glass transition temperature of 160° C. by ASTM D3418 and a melt flow rate of 4 g/10 min by ASTM D1238 measured at 260° C. Teflon™ AF1600 is alternately referred to in these examples as “AF”. Teflon™ AF1600 is a commercial product of The Chemours Co.

Functional Fluoropolymer (FF)—Copolymer of 50 mole % tetrafluoroethylene, 48.5 mole % ethyl vinyl ether and 1.5 mole % vinyl triisopropoxysilane, synthesized as described in Example 1 of WO 2019/018346 A1, which is incorporated herein by reference. Herein in these examples this copolymer is alternately referred to as “FF”.

Ethoxy-nonafluorobutane (C₄F₉OC₂H₅) solvent, 3M™ Novec™ 7200 Engineered Fluid, a commercial product of 3M™. Herein in these examples referred to as “HFE7200”.

### Preparation of Liquid Composition Coating Solutions of Amorphous Perfluopolymer (AF) and Functional Fluoropolymer (FF)

This is the preparation of a liquid compositions comprising fluorinated solvent and dissolved therein a present fluoropolymer composition comprising amorphous perfluoropolymer and functional fluoropolymer.

A 4 wt % solution of AF in HFE7200 is prepared by adding the AF to the HFE7200 and shaking the mixture on a Burrell Wrist-Action shaker for 3 days at room temperature. Solutions of 0.01 wt % and 0.1 wt % FF in HFE7200 are prepared by adding the FF to the HFE7200 and stirring at room temperature. Liquid compositions containing different amounts of both AF and FF as reported in Table 1 were prepared by mixing the amounts of the AF and FF solutions for 30 seconds using a vortex mixer, which is sufficient to blend all ingredients, since all solids are dissolved. Each liquid composition of AF+FF is then diluted to 2 wt % total solids by the addition of additional HFE7200 to make the coating solution. The percent AF reported is the percent of AF based on the total solids weight of AF and FF.

TABLE 1

| | Coating Solutions - amounts of solutions added to make | | | |
|---|---|---|---|---|
| | each liquid composition of AF + FF | | | |
| % AF of | g 4% AF in | g 0.01% FF in | g 0.1% FF in | |
| total solids | HFE 7200 | HFE7200 | HFE7200 | g HFE7200 |
| 100.00 | 12.000 | 0.000 | 0.000 | 12.000 |
| 99.99 | 11.999 | 0.050 | 0.000 | 11.952 |
| 99.9 | 11.988 | 0.496 | 0.000 | 11.516 |
| 99.5 | 11.940 | 2.480 | 0.000 | 9.580 |
| 99 | 11.880 | 0.000 | 0.496 | 11.624 |
| 98.5 | 11.820 | 0.000 | 0.744 | 11.436 |
| 98 | 11.760 | 0.000 | 0.992 | 11.248 |
| 97 | 11.640 | 0.000 | 1.488 | 10.872 |
| 96 | 11.520 | 0.000 | 1.984 | 10.496 |
| 95 | 11.400 | 0.000 | 2.480 | 10.120 |
| 94 | 11.280 | 0.000 | 2.976 | 9.744 |
| 93 | 11.160 | 0.000 | 3.472 | 9.368 |
| 92 | 11.040 | 0.000 | 3.968 | 8.992 |
| 91 | 10.920 | 0.000 | 4.464 | 8.616 |
| 90 | 10.800 | 0.000 | 4.960 | 8.240 |

### Preparation of Coated Substrates

Preparation of Slides Soda lime glass slides (3″×1″) are placed in a solution of 2.5 M NaOH for 2.5 hrs. They are then transferred to deionized (DI) water and placed in an ultrasonic bath and sonicated for 10 minutes. The slides are then moved to a 0.01 M HCl solution to remove residual base for 10 minutes. After further sonicating in DI water for 10 minutes, the slides are then rinsed or soaked with methanol and subsequently moved to a glass drying oven set at 130° C. The slides are allowed to remain in the oven until they are ready for coating.

Spin Coating of Slides with Fluoropolymer Coating Solution

The slides as prepared above were taped to a 3″ diameter glass wafer and placed on a spin coater vacuum chuck. Then 1.25 mL of AF+FF coating solution is added to the surface of the slide. The slide is then spun after application of the AF+FF solution at 2,000 RPM for 20 seconds. The glass slide was then removed from the glass wafer and placed on a 70° C. hot place for 2 minutes to remove remaining solvent.

Curing of Coated Slides

The coated glass slides were then cured at 200° C. for 2 hours. During cure, a nitrogen flow saturated with moist HCl by passing through a fritted bubbler in a 1 M solution of HCl is introduced into the curing chamber. After 2 hours, the slides are cooled to room temperature.

### Measurement of Sliding Angle

A Ramé-Hart goniometer was used to record the sliding angle of the surface of a slide coated with a fluoropolymer composition. A single 10 μL drop of deionized water was placed on the slide and then the goniometer automated procedure run whereby the slide was tilted at 1 degree per second. The drop of water was monitored and the goniometer stopped at the angle the drop of water began to roll off the slide under its own momentum, and the angle is recorded. This measurement is repeated three times for each slide. A total of six slides were tested for each fluoropolymer composition, this testing procedure resulting in 18 sliding angles measurements perfluoropolymer coating composition. The results of the sliding angle experiments are reported in Table 2.

As a comparative example, a 100% AF fluoropolymer coating on the glass slide gave an average sliding angle of 17.4 degrees. It was not possible to measure a sliding angle for a 100% FE coating on the glass slide, as the sliding angle was too high to measure.

TABLE 2

| % AF of | Sliding | Sliding | Sliding | Average of | Sliding angle |
|---|---|---|---|---|---|
| total | angle | angle | angle | three sliding | sample, |
| solids - | sample | sample | sample | angle | standard |
| Sample | 1, | 2, | 3, | samples, | deviation, |
| ID # | degrees | degrees | degrees | degrees | degrees |
| 90-1 | 34 | 35 | 35 | 34.7 | 0.6 |
| 90-2 | 30 | 31 | 31 | 30.7 | 0.6 |
| 90-3 | 32 | 32 | 33 | 32.3 | 0.6 |
| 90-4 | 40 | 29 | 32 | 33.7 | 5.7 |
| 90-5 | 35 | 38 | 33 | 35.3 | 2.5 |
| 90-6 | 30 | 30 | 30 | 30.0 | 0.0 |
| 90% AF | 33.5 | 32.5 | 32.3 | 32.8 | 0.6 |
| Combined | | | | | |
| 92-1 | 38 | 27 | 27 | 30.7 | 6.4 |
| 92-2 | 27 | 26 | 25 | 26.0 | 1.0 |
| 92-3 | 27 | 25 | 25 | 25.7 | 1.2 |
| 92-4 | 26 | 27 | 26 | 26.3 | 0.6 |
| 92-5 | 29 | 30 | 28 | 29.0 | 1.0 |
| 92-6 | 24 | 25 | 25 | 24.7 | 0.6 |
| 92% AF | 28.5 | 26.7 | 26.0 | 27.1 | 1.3 |
| Combined | | | | | |
| 93-1 | 27 | 24 | 27 | 26.0 | 1.7 |
| 93-2 | 28 | 27 | 28 | 27.7 | 0.6 |
| 93-3 | 21 | 22 | 22 | 21.7 | 0.6 |
| 93-4 | 26 | 27 | 26 | 26.3 | 0.6 |
| 93-5 | 27 | 26 | 27 | 26.7 | 0.6 |
| 93-6 | 29 | 30 | 32 | 30.3 | 1.5 |
| 93% AF | 26.3 | 26.0 | 27.0 | 26.4 | 0.5 |
| Combined | | | | | |
| 94-1 | 26 | 26 | 26 | 26.0 | 0.0 |
| 94-2 | 23 | 25 | 24 | 24.0 | 1.0 |
| 94-3 | 28 | 28 | 27 | 27.7 | 0.6 |
| 94-4 | 28 | 26 | 28 | 27.3 | 1.2 |
| 94-5 | 27 | 27 | 28 | 27.3 | 0.6 |
| 94-6 | 30 | 29 | 27 | 28.7 | 1.5 |
| 94% AF | 27.0 | 26.8 | 26.7 | 26.8 | 0.2 |
| Combined | | | | | |
| 95-1 | 25 | 31 | 23 | 26.3 | 4.2 |
| 95-2 | 29 | 24 | 23 | 25.3 | 3.2 |
| 95-3 | 30 | 26 | 25 | 27.0 | 2.6 |
| 95-4 | 26 | 35 | 26 | 29.0 | 5.2 |
| 95-5 | 33 | 30 | 25 | 29.3 | 4.0 |
| 95-6 | 22 | 22 | 22 | 22.0 | 0.0 |
| 95% AF | 27.5 | 28.0 | 24.0 | 26.5 | 2.2 |
| Combined | | | | | |
| 98.5-1 | 24 | 26 | 26 | 25.3 | 1.2 |
| 98.5-2 | 26 | 28 | 25 | 26.3 | 1.5 |
| 98.5-3 | 26 | 27 | 25 | 26.0 | 1.0 |
| 98.5-4 | 25 | 25 | 28 | 26.0 | 1.7 |
| 98.5-5 | 24 | 23 | 23 | 23.3 | 0.6 |
| 98.5-6 | 23 | 26 | 25 | 24.7 | 1.5 |
| 98.5% AF | 24.7 | 25.8 | 25.3 | 25.3 | 0.6 |
| Combined | | | | | |

### Measurement of Adhesion

The ASTM D3359 method is used to assess adhesion. A 5×5 cross hatch is cut in the fluoropolymer coating using an Elcometer 1542 Cross Hatch Adhesion Tester kit to produce the cut. Each resulting square measures 1 mm×1 mm. A “before” image is recorded on a Keyence microscope. ASTM D3359 approved tape is then applied firmly to the coating surface, entirely covering the 5×5 matrix, and any bubbles are eliminated by even application of pressure. After waiting an average of 90 seconds, the tape is then removed by hand by pulling the tape away from the coated surfaced at an angle as close to 180 degrees as possible. The squares remaining in the 5×5 matrix are counted and the general adhesion quality is observed. The results are shown in Table 3, wherein a score of 25/25 indicates perfect adhesion (no coating squares removed with the tape) and a score of 0/25 indicates complete removal of the 5×5 matrix (all coating squares removed by the tape).

TABLE 3

| % AF of total | # of squares of fluoropolymer coating remaining | |
|---|---|---|
| solids | on substrate after pulling tape (#trials) | |
| 100 | 0 | (5) |
| 99.99 | 0 | (5) |
| 99.9 | 0 | (5) |
| 99.5 | 0 | (4) |
| 99.0 | 11, 14, 25, 25 | (4) |
| 98.5 | 16, 18, 23, 25, 25 | (5) |
| 98.0 | 25 | (5) |

From the adhesion test results in Table 3, it can be seen that perfect adhesion (25/25, all 5×5 matrix squares remain adhered to substrate after the tape strip is pulled) was observed for the mixtures of amorphous perfluopolymer (AF) and functional fluoropolymer (FF) containing about 2 weight percent and higher of FF. For AF and FF mixtures containing less than 0.5 weight percent FF it can be seen that little to no adhesion benefit was observed.

From the sliding angle test results in Table 2, it can be seen that sliding angle increases with higher weight percentages of FF in the AF and FF composition. For AF and FF mixtures containing 0.5 weight percent FF it was observed that the average sliding angle slightly increases to an average of 25.3 degrees, up from the 17.4 degree sliding angle for 100% AF. As the amount of FF in the AF and FF mixture is increased, the average sliding angle does not substantially increase from about 26 degrees until the amount of FF in the AF and FF mixture is in the range of 8-10 weight percent.

### Other Embodiments

1. In some embodiments, the present application provides a fluoropolymer composition comprising:
i) amorphous perfluoropolymer comprising copolymerized units of at least one perfluorinated monomer, and
ii) functional fluoropolymer comprising copolymerized units of:
   (a) fluoroolefin selected from the group consisting of tetrafluoroethylene, chlorotrifluoroethylene, hexafluoropropylene, perfluoro(methyl vinyl ether), perfluoro(ethyl vinyl ether), and perfluoro(propyl vinyl ether);
   (b) alkyl vinyl ether wherein the alkyl group is a C1 to C6 straight chain alkyl radical or a C3 to C6 branched chain or cyclic alkyl radical, or aryl vinyl ether wherein the aryl group is unsubstituted or substituted; and
   (c) alkenyl silane of the formula SiR1R2R3R4, wherein R1 is an alkenyl radical, R2 and R3 are independently selected from substituted or unsubstituted aryl, substituted or unsubstituted aryl substituted alkyl radical, substituted or unsubstituted linear or branched alkoxy radical, substituted or unsubstituted cyclic alkoxy radical, substituted or unsubstituted linear or branched alkyl radical, or substituted or unsubstituted cyclic alkyl radical, and R4 is substituted or unsubstituted linear or branched alkoxy radical, or substituted or unsubstituted cyclic alkoxy radical.

2. The fluoropolymer composition of Embodiment 1, wherein
(a) said fluoroolefin is tetrafluoroethylene, (b) said alkyl vinyl ether, wherein the alkyl group of said alkyl vinyl ether is a C1 to C6 straight chain alkyl radical; and (c) said alkenyl silane is of the formula SiR1R2R3R4, wherein R1 is an alkenyl radical, R2 is aryl, aryl substituted alkyl radical, branched C3-C6 alkoxy radical, or substituted or unsubstituted cyclic C5-C6 alkoxy radical, and R3 and R4 are independently selected from linear or branched C1-C6 alkoxy radical, or substituted or unsubstituted cyclic C5-C6 alkoxy radical.

3. The fluoropolymer composition of Embodiments 1 or 2, wherein said composition contains an amount of functional fluoropolymer effective to improve the adhesion of said amorphous perfluoropolymer to a substrate.

4. The fluoropolymer composition of any one of Embodiments 1-3, containing from about 0.5 to about 5 weight percent of said functional fluoropolymer based on the combined weights of said amorphous perfluoropolymer and said functional fluoropolymer.

5. The fluoropolymer composition of any one of Embodiments 1-4, wherein said functional fluoropolymer comprises copolymerized units of: (a) tetrafluoroethylene; (b) methyl vinyl ether or ethyl vinyl ether; and (c) vinyltriisopropoxysilane.

6. The fluoropolymer composition of any one of Embodiments 1-5, wherein said amorphous perfluoropolymer comprises copolymerized units of tetrafluoroethylene and at least one additional perfluorinated monomer.

7. The fluoropolymer composition of any one of Embodiments 1-6, wherein said amorphous perfluoropolymer comprises copolymerized units of tetrafluoroethylene and at least one perfluorinated monomer selected from the group consisting of: hexafluoropropylene (HFP); perfluoro(methyl vinyl ether) (PMVE), perfluoro(ethyl vinyl ether) (PEVE), perfluoro(propyl vinyl ether) (PPVE); perfluoro(1,3-dioxole); perfluoro(2,2-dimethyl-1,3-dioxole) (PDD); perfluoro(2-methylene-4-methyl-1,3-dioxolane) (PMD); CF₂═CFOCF₂CF═CF₂, CF₂═CFOCF₂CF₂CF═CF₂; and CF₂═CFOCF₂CF₂OCF═CF₂.

8. The fluoropolymer composition of any one of Embodiments 1-7, wherein said amorphous perfluoropolymer comprises copolymerized units of tetrafluoroethylene and perfluoro(2,2-dimethyl-1,3-dioxole).

9. The fluoropolymer composition of any one of Embodiments 1-8, wherein said amorphous perfluoropolymer has a heat of fusion calculated from any endotherm detected in a differential scanning calorimetry (DSC) scan for the as-polymerized amorphous perfluoropolymer that is no more than about 3 J/g.

10. The fluoropolymer composition of any one of Embodiments 1-9, wherein said amorphous perfluoropolymer has a heat of fusion calculated from any endotherm detected in a differential scanning calorimetry (DSC) scan for the as-polymerized amorphous perfluoropolymer that is no more than about 1 J/g.

11. A liquid composition of fluoropolymer comprising fluorinated solvent and dissolved therein said fluoropolymer composition of any one of Embodiments 1-10.

12. The liquid composition of Embodiment 11, wherein said liquid composition contains about 15 weight percent or less of said fluoropolymer composition dissolved in said fluorinated solvent.

13. A coated article comprising a substrate having a coating of said fluoropolymer composition of any one of Embodiments 1-10.

14. The coated article of Embodiment 13, wherein said coating has a thickness of from about 0.025 to about 100 micrometers.

15. The coated article of Embodiments 13 or 14, wherein said substrate comprises glass and said fluoropolymer composition comprises amorphous perfluoropolymer comprising copolymerized units of tetrafluoroethylene and perfluoro(2,2-dimethyl-1,3-dioxole), and said functional fluoropolymer comprises copolymerized units of: (a) tetrafluoroethylene; (b) methyl vinyl ether or ethyl vinyl ether; and (c) vinyltriisopropoxysilane.

16. The coated article of any one of Embodiments 13-15, wherein said coating has greater adhesion to said substrate than the adhesion of an equivalent coating containing only said amorphous perfluoropolymer.

17. A coated article comprising a substrate having a fluoropolymer coating comprising a fluoropolymer composition, wherein said fluoropolymer composition comprises:
i) amorphous perfluoropolymer comprising copolymerized units of tetrafluoroethylene and perfluoro(2,2-dimethyl-1,3-dioxole), and
ii) functional fluoropolymer comprising copolymerized units of
   (a) tetrafluoroethylene;
   (b) alkyl vinyl ether wherein the alkyl group is a C1 to C6 straight chain alkyl radical or a C3 to C6 branched chain or cyclic alkyl radical, or aryl vinyl ether wherein the aryl group is unsubstituted or substituted; and
   (c) alkenyl silane of the formula SiR1R2R3R4, wherein R1 is an alkenyl radical, R2 and R3 are independently selected from substituted or unsubstituted aryl, substituted or unsubstituted aryl substituted alkyl radical, substituted or unsubstituted linear or branched alkoxy radical, substituted or unsubstituted cyclic alkoxy radical, substituted or unsubstituted linear or branched alkyl radical, or substituted or unsubstituted cyclic alkyl radical, and R4 is substituted or unsubstituted linear or branched alkoxy radical, or substituted or unsubstituted cyclic alkoxy radical, and
said fluoropolymer composition containing from about 1 to about 5 weight percent of said functional fluoropolymer based on the combined weight of said amorphous perfluoropolymer and said functional fluoropolymer, and
the adhesion of said fluoropolymer coating to said substrate as determined by the ASTM D3359 method results in at least about 75% of the coating squares remaining in the 5×5 test matrix, and
the sliding angle of said fluoropolymer coating as measured by Goniometer is about 27 degrees or less.

18. A coated article comprising a substrate having a fluoropolymer coating comprising a fluoropolymer composition, wherein said fluoropolymer composition comprises:
i) amorphous perfluoropolymer comprising copolymerized units of tetrafluoroethylene and perfluoro(2,2-dimethyl-1,3-dioxole), and
ii) functional fluoropolymer comprising copolymerized units of
   (a) tetrafluoroethylene;
   (b) alkyl vinyl ether wherein the alkyl group is a C1 to C6 straight chain alkyl radical or a C3 to C6 branched chain or cyclic alkyl radical, or aryl vinyl ether wherein the aryl group is unsubstituted or substituted; and
   (c) alkenyl silane of the formula SiR1R2R3R4, wherein R1 is an alkenyl radical, R2 and R3 are independently selected from substituted or unsubstituted aryl, substituted or unsubstituted aryl substituted alkyl radical, substituted or unsubstituted linear or branched alkoxy radical, substituted or unsubstituted cyclic alkoxy radical, substituted or unsubstituted linear or branched alkyl radical, or substituted or unsubstituted cyclic alkyl radical, and R4 is substituted or unsubstituted linear or branched alkoxy radical, or substituted or unsubstituted cyclic alkoxy radical, and
said fluoropolymer composition containing from about 2 to about 3 weight percent of said functional fluoropolymer based on the combined weight of said amorphous perfluoropolymer and said functional fluoropolymer, and
the adhesion of said fluoropolymer coating to said substrate as determined by the ASTM D3359 method results in about 100% of the coating squares remaining in the 5×5 test matrix, and
the sliding angle of said fluoropolymer coating as measured by Goniometer is about 26 degrees or less.

19. A process for improving the adhesion of amorphous perfluoropolymer to a substrate, comprising
combining said amorphous perfluoropolymer with a functional fluoropolymer to form a fluoropolymer composition, and
forming a coating of said fluoropolymer composition on at least a portion of the surface of said substrate,
whereby said coating has greater adhesion to said substrate than the adhesion of an equivalent coating free from said functional fluoropolymer, and
wherein said functional fluoropolymer comprises copolymerized units of: (a) fluoroolefin selected from the group consisting of tetrafluoroethylene, chlorotrifluoroethylene, hexafluoropropylene, perfluoro(methyl vinyl ether), perfluoro(ethyl vinyl ether), and perfluoro(propyl vinyl ether); (b) alkyl vinyl ether wherein the alkyl group is a C1 to C6 straight chain alkyl radical or a C3 to C6 branched chain or cyclic alkyl radical, or aryl vinyl ether wherein the aryl group is unsubstituted or substituted; and (c)alkenyl silane of the formula SiR1R2R3R4, wherein R1 is an alkenyl radical, R2 and R3 are independently selected from substituted or unsubstituted aryl, substituted or unsubstituted aryl substituted alkyl radical, substituted or unsubstituted linear or branched alkoxy radical, substituted or unsubstituted cyclic alkoxy radical, substituted or unsubstituted linear or branched alkyl radical, or substituted or unsubstituted cyclic alkyl radical, and R4 is substituted or unsubstituted linear or branched alkoxy radical, or substituted or unsubstituted cyclic alkoxy radical.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims. It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

What is claimed is the following:

1. A fluoropolymer composition comprising:
i) amorphous perfluoropolymer comprising copolymerized units of at least one perfluorinated monomer, and
ii) functional fluoropolymer comprising copolymerized units of:
(a) fluoroolefin selected from the group consisting of tetrafluoroethylene, chlorotrifluoroethylene, hexafluoropropylene, perfluoro(methyl vinyl ether), perfluoro(ethyl vinyl ether), and perfluoro(propyl vinyl ether);
(b) alkyl vinyl ether wherein the alkyl group is a C1 to C6 straight chain alkyl radical or a C3 to C6 branched chain or cyclic alkyl radical, or aryl vinyl ether wherein the aryl group is unsubstituted or substituted; and
(c) alkenyl silane of the formula SiR1R2R3R4, wherein R1 is an alkenyl radical, R2 and R3 are independently selected from substituted or unsubstituted aryl, substituted or unsubstituted aryl substituted alkyl radical, substituted or unsubstituted linear or branched alkoxy radical, substituted or unsubstituted cyclic alkoxy radical, substituted or unsubstituted linear or branched alkyl radical, or substituted or unsubstituted cyclic alkyl radical, and R4 is substituted or unsubstituted linear or branched alkoxy radical, or substituted or unsubstituted cyclic alkoxy radical.

2. The fluoropolymer composition of claim 1, wherein (a) said fluoroolefin is tetrafluoroethylene, (b) said alkyl vinyl ether, wherein the alkyl group is a C1 to C6 straight chain alkyl radical; and (c) said alkenyl silane is of the formula SiR1R2R3R4, wherein R1 is an alkenyl radical, R2 is aryl, aryl substituted alkyl radical, branched C3-C6 alkoxy radical, or substituted or unsubstituted cyclic C5-C6 alkoxy radical, and R3 and R4 are independently selected from linear or branched C1-C6 alkoxy radical, or substituted or unsubstituted cyclic C5-C6 alkoxy radical.

3. The fluoropolymer composition of claim 1, wherein said composition contains an amount of functional fluoropolymer effective to improve the adhesion of said amorphous perfluoropolymer to a substrate.

4. The fluoropolymer composition of claim 1, containing from about 0.5 to about 5 weight percent of said functional fluoropolymer based on the combined weights of said amorphous perfluoropolymer and said functional fluoropolymer.

5. The fluoropolymer composition of claim 1, wherein said functional fluoropolymer comprises copolymerized units of: (a) tetrafluoroethylene; (b) methyl vinyl ether or ethyl vinyl ether; and (c) vinyltriisopropoxysilane.

6. The fluoropolymer composition of claim 1, wherein said amorphous perfluoropolymer comprises copolymerized units of tetrafluoroethylene and at least one additional perfluorinated monomer.

7. The fluoropolymer composition of claim 1, wherein said amorphous perfluoropolymer comprises copolymerized units of tetrafluoroethylene and perfluoro(2,2-dimethyl-1,3-dioxole).

8. The fluoropolymer composition of claim 1, wherein said amorphous perfluoropolymer comprises copolymerized units of tetrafluoroethylene and at least one perfluorinated monomer selected from the group consisting of: hexafluoropropylene (HFP); perfluoro(methyl vinyl ether) (PMVE), perfluoro(ethyl vinyl ether) (PEVE), perfluoro(propyl vinyl ether) (PPVE); perfluoro(1,3-dioxole); perfluoro(2,2-dimethyl-1,3-dioxole) (PDD); perfluoro(2-methylene-4-methyl-1,3-dioxolane) (PMD);
CF₂═CFOCF₂CF═CF₂, CF₂═CFOCF₂CF₂CF═CF₂; and
CF₂═CFOCF₂CF₂OCF═CF₂.

9. The fluoropolymer composition of claim 1, wherein said amorphous perfluoropolymer has a heat of fusion calculated from any endotherm detected in a differential scanning calorimetry (DSC) scan for the as-polymerized amorphous perfluoropolymer that is no more than about 3 J/g.

10. The fluoropolymer composition of claim 1, wherein said amorphous perfluoropolymer has a heat of fusion calculated from any endotherm detected in a differential scanning calorimetry (DSC) scan for the as-polymerized amorphous perfluoropolymer that is no more than about 1 J/g.

11. A liquid composition of fluoropolymer comprising fluorinated solvent and dissolved therein said fluoropolymer composition of claim 1.

12. The liquid composition of claim 11, wherein said liquid composition contains about 15 weight percent or less of said fluoropolymer composition dissolved in said fluorinated solvent.

13. A coated article comprising a substrate having a coating of said fluoropolymer composition of claim 1.

14. The coated article of claim 13, wherein said coating has a thickness of from about 0.025 to about 100 micrometers.

15. The coated article of claim 13, wherein said substrate comprises glass and said fluoropolymer composition comprises amorphous perfluoropolymer comprising copolymerized units of tetrafluoroethylene and perfluoro(2,2-dimethyl-1,3-dioxole), and said functional fluoropolymer comprises copolymerized units of: (a) tetrafluoroethylene; (b) methyl vinyl ether or ethyl vinyl ether; and (c) vinyltriisopropoxysilane.

16. The coated article of claim 15, wherein said coating has greater adhesion to said substrate than the adhesion of an equivalent coating containing only said amorphous perfluoropolymer.

17. A coated article comprising a substrate having a fluoropolymer coating comprising a fluoropolymer composition, wherein said fluoropolymer composition comprises:
i) amorphous perfluoropolymer comprising copolymerized units of tetrafluoroethylene and perfluoro(2,2-dimethyl-1,3-dioxole), and
ii) functional fluoropolymer comprising copolymerized units of
(a) tetrafluoroethylene;
(b) alkyl vinyl ether wherein the alkyl group is a C1 to C6 straight chain alkyl radical or a C3 to C6 branched chain or cyclic alkyl radical, or aryl vinyl ether wherein the aryl group is unsubstituted or substituted; and
(c) alkenyl silane of the formula SiR1R2R3R4, wherein R1 is an alkenyl radical, R2 and R3 are independently selected from substituted or unsubstituted aryl, substituted or unsubstituted aryl substituted alkyl radical, substituted or unsubstituted linear or branched alkoxy radical, substituted or unsubstituted cyclic alkoxy radical, substituted or unsubstituted linear or branched alkyl radical, or substituted or unsubstituted cyclic alkyl radical, and R4 is substituted or unsubstituted linear or branched alkoxy radical, or substituted or unsubstituted cyclic alkoxy radical, and
said fluoropolymer composition containing from about 1 to about 5 weight percent of said functional fluoropolymer based on the combined weight of said amorphous perfluoropolymer and said functional fluoropolymer, and
the adhesion of said fluoropolymer coating to said substrate as determined by the ASTM D3359 method results in at least about 75% of the coating squares remaining in the 5×5 test matrix, and
the sliding angle of said fluoropolymer coating as measured by Goniometer is about 27 degrees or less.

18. A coated article comprising a substrate having a fluoropolymer coating comprising a fluoropolymer composition, wherein said fluoropolymer composition comprises:
i) amorphous perfluoropolymer comprising copolymerized units of tetrafluoroethylene and perfluoro(2,2-dimethyl-1,3-dioxole), and
ii) functional fluoropolymer comprising copolymerized units of
(a) tetrafluoroethylene;
(b) alkyl vinyl ether wherein the alkyl group is a C1 to C6 straight chain alkyl radical or a C3 to C6 branched chain or cyclic alkyl radical, or aryl vinyl ether wherein the aryl group is unsubstituted or substituted; and
(c) alkenyl silane of the formula SiR1R2R3R4, wherein R1 is an alkenyl radical, R2 and R3 are independently selected from substituted or unsubstituted aryl, substituted or unsubstituted aryl substituted alkyl radical, substituted or unsubstituted linear or branched alkoxy radical, substituted or unsubstituted cyclic alkoxy radical, substituted or unsubstituted linear or branched alkyl radical, or substituted or unsubstituted cyclic alkyl radical, and R4 is substituted or unsubstituted linear or branched alkoxy radical, or substituted or unsubstituted cyclic alkoxy radical, and
said fluoropolymer composition containing from about 2 to about 3 weight percent of said functional fluoropolymer based on the combined weight of said amorphous perfluoropolymer and said functional fluoropolymer, and
the adhesion of said fluoropolymer coating to said substrate as determined by the ASTM D3359 method results in about 100% of the coating squares remaining in the 5×5 test matrix, and
the sliding angle of said fluoropolymer coating as measured by Goniometer is about 26 degrees or less.

19. A process for improving the adhesion of amorphous perfluoropolymer to a substrate, comprising
combining said amorphous perfluoropolymer with a functional fluoropolymer to form a fluoropolymer composition, and
forming a coating of said fluoropolymer composition on at least a portion of the surface of said substrate,
whereby said coating has greater adhesion to said substrate than the adhesion of an equivalent coating free from said functional fluoropolymer, and
wherein said functional fluoropolymer comprises copolymerized units of: (a) fluoroolefin selected from the group consisting of tetrafluoroethylene, chlorotrifluoroethylene, hexafluoropropylene, perfluoro(methyl vinyl ether), perfluoro(ethyl vinyl ether), and perfluoro(propyl vinyl ether); (b) alkyl vinyl ether wherein the alkyl group is a C1 to C6 straight chain alkyl radical or a C3 to C6 branched chain or cyclic alkyl radical, or aryl vinyl ether wherein the aryl group is unsubstituted or substituted; and (c) alkenyl silane of the formula SiR1R2R3R4, wherein R1 is an alkenyl radical, R2 and R3 are independently selected from substituted or unsubstituted aryl, substituted or unsubstituted aryl substituted alkyl radical, substituted or unsubstituted linear or branched alkoxy radical, substituted or unsubstituted cyclic alkoxy radical, substituted or unsubstituted linear or branched alkyl radical, or substituted or unsubstituted cyclic alkyl radical, and R4 is substituted or unsubstituted linear or branched alkoxy radical, or substituted or unsubstituted cyclic alkoxy radical.
